(19) United States
(12) Patent Application Publication
(10) Pub. No.: US 2014/0213129 A1
(43) Pub. Date: Jul. 31, 2014

(54) Multi-Layer Pad Structure through Needle Punching Working Procedure

(71) Applicant: MING-SHUN YANG, Taipei (TW)

(72) Inventor: MING-SHUN YANG, Taipei (TW)

(73) Assignee: FORMOSA SAINT JOSE CORPORATION, TAIPEI (TW)

(21) Appl. No.: 13/866,938

(22) Filed: Apr. 19, 2013

(30) Foreign Application Priority Data
Jan. 31, 2013 (TW) 102103632

(51) Int. Cl. B32B 5/02

(52) U.S. Cl. CPC B32B 5/028; B32B 5/022
USPC 442/1

(57) ABSTRACT

A multi-layer pad structure through needle punching working procedure is provided. The multi-layer pad structure comprises: a material layer which is a wrap knitted fabric with at least one mesh; and a base layer, which is a non-woven fabric surface composed of a needle punching cotton silk fiber, combined with the material layer tightly by embedding the needle punching cotton silk fiber into the material layer through needle punching working procedure. Accordingly, the defects of poor gluing level, high gluing cost, easy-deteriorated glue and non-environmentally protection existed in the previous multi-layer pad structure products can be improved.

### CROSS-REFERENCES TO RELATED APPLICATIONS

Not applicable.

### BACKGROUND OF THE INVENTION

1. Field of the Invention

The present invention relates to a multi-layer pad structure. The multi-layer pad structure comprises a material layer and a base layer which are combined tightly through needle punching working procedure.

### DESCRIPTIONS OF THE RELATED ART

The previous multi-layer pad structure products are usually made by gluing a material layer and a base layer with glue. The material layer is a wrap knitted fabric with meshes.

However, there are some defects existing in the previous multi-layer pad structure products as follows:

1. poor gluing level: When the material layer is glued to the base layer with the glue, the gluing level is very poor since the areas overlapped between the material and the base layer (the areas of deducting the areas of meshes from the total areas of the material) is very limited due to the meshes of the material layer.

2. high gluing cost: In the previous multi-layer pad structure products, the material layers are stuck with the base layer by the glue for combining with each other tightly. However, the manufacturing cost of the previous multi-layer pad structure products will be substantially increased since the cost of the glues is extremely high. Therefore, it is very uneconomical.

3. easy-deteriorated glue: After sticking the material layer with the base layer by the glue, the glue will be harden and lose the effect of gluing after being oxidized by contacting air, water or sunlight. Worse, even the material layer could be detached from the base layer subsequently.

4. non-environmentally protection: In this art, superglue is usually used as the glue. However, superglue is not only expensive but chemical-poisonous. Accordingly, superglue causes not only the risk of chronic poison to the operators in the manufactory, but the long term chemical-poisonous to the consumers and the environment, which is quite non-environmentally protection.

It can be seen that the previous multi-layer pad structure products are not well-designed since there are defects of poor gluing level, high gluing cost, easy-deteriorated glue and non-environmentally protection. Therefore, it needs to be improved urgently.

### BRIEF SUMMARY OF THE INVENTION

In view of the defects of poor gluing level, high gluing cost, easy-deteriorated glue and non-environmentally protection existed in the previous multi-layer structure products, the applicant has developed a multi-layer pad structure through needle punching working procedure based on the related working experiences and researches in the past few years.

One objective of this invention is to provide a multi-layer pad structure which comprises a material layer and a base layer. The material layer and the base layer are combined tightly through a needle punching working procedure. The material layer is a wrap knitted fabric with at least one mesh, which is formed by a plurality of first fiber silks and a plurality of second fiber silks. The first fiber silks are single silk fibers and the second fiber silks are synthetic fiber silks. Each of the first fiber silks is bended as an U-shape ring with a ring part and two tails of single silk fiber for forming the mesh. Each ring part is clasped with the ring part of another first fiber silk while the tails go through the ring part of another first fiber silk. A single yarn is formed by clasping several first fiber silks in such way. One of the second fiber silks is disposed beside each first fiber silk of the single yarn at one-first fiber silk interval. The one of the second fiber silks is crosswise disposed beside the first fiber silks of another single yarn, and crosswise disposed back beside the first fiber silks of the single yarn. By such twisting way, the single yarn is fixed with another single yarn, and then the material layer is formed by twisting several single yarns. The material layer is covered by the base layer. Meanwhile, through needle punching working procedure, a needle punching cotton silk fiber of the base layer is embedded into spaces between the first fiber silks and the second fiber silks and interknits therewithin so that the material layer is combined with the base layer tightly to form the multi-layer pad structure of the present invention. Accordingly, the defects of poor gluing level, high gluing cost, easy-deteriorated glue and non-environmentally protection existed in the previous multi-layer pad structure products can be improved based on the present invention.

### BRIEF DESCRIPTION OF THE DRAWINGS

FIG. 1 is a perspective view of the material layer of the present invention;

FIG. 1A is a partial enlargement view of the material layer of the present invention;

FIG. 2 is a schematic view of the twist of the single yarn with another single yarn of the present invention;

FIG. 3 is a perspective view of the twist of the single yarn with another single yarn of the present invention;

FIG. 4 is a schematic view of embedding the needle punching cotton silk fiber of the base layer into the spaces between the first fiber silks and the second fiber silks through needle punching working procedure; and

FIG. 5 is a perspective view of the present invention.

### DETAILED DESCRIPTION OF THE INVENTION

The details are described in the following paragraphs accompanying the appended drawings and description for Examiner to further understand the features of the present invention.

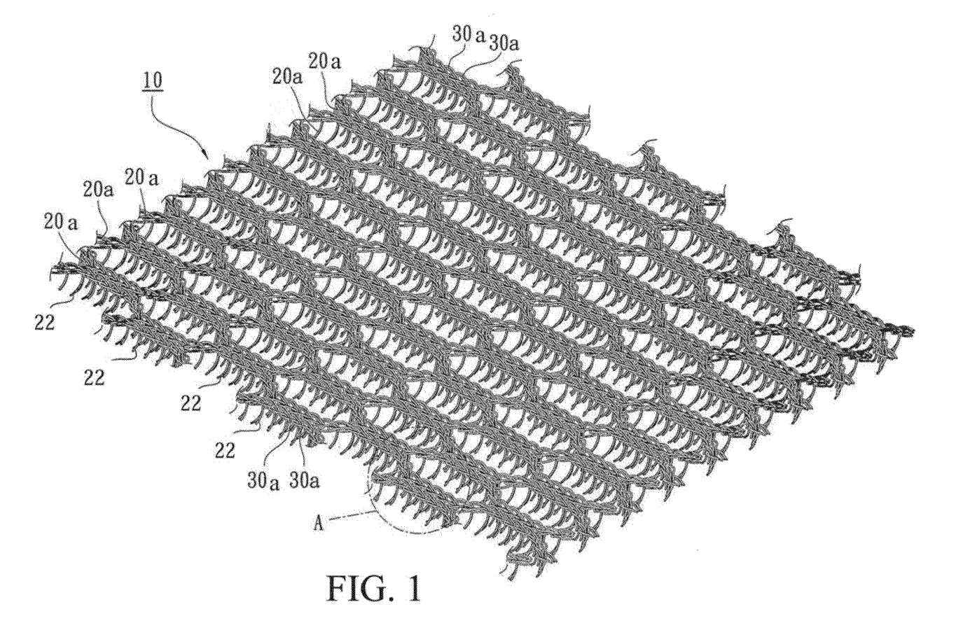

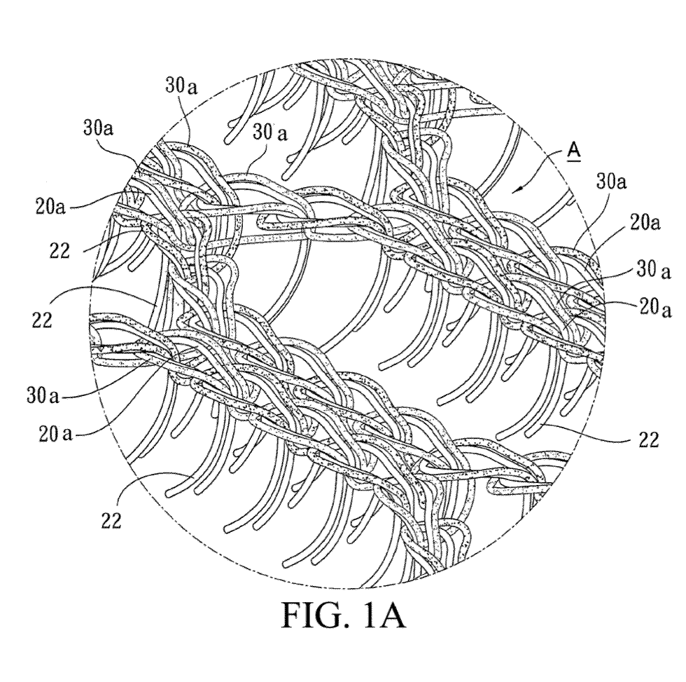

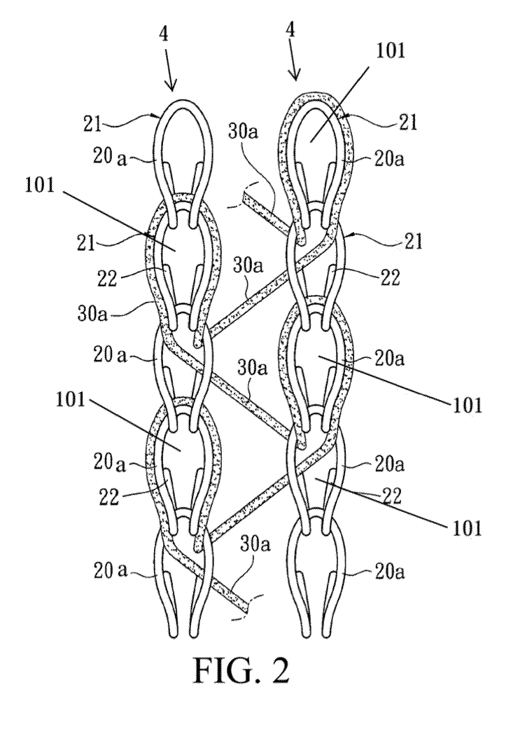

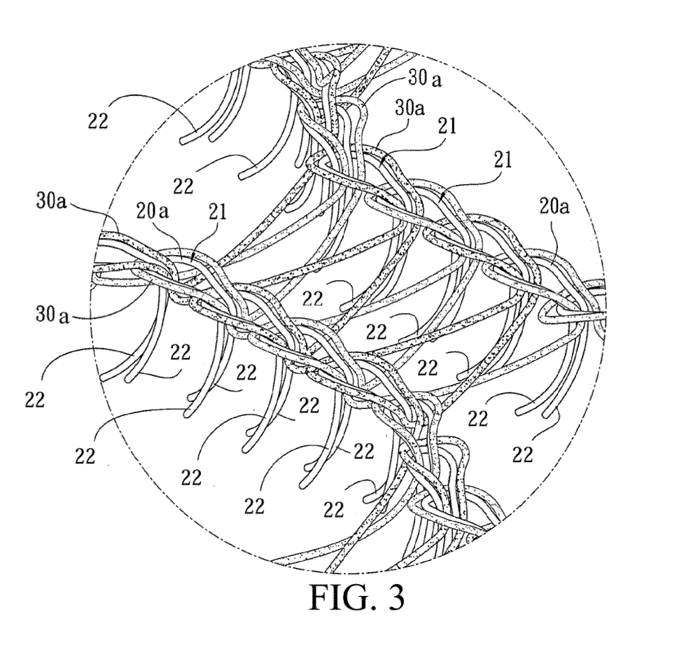

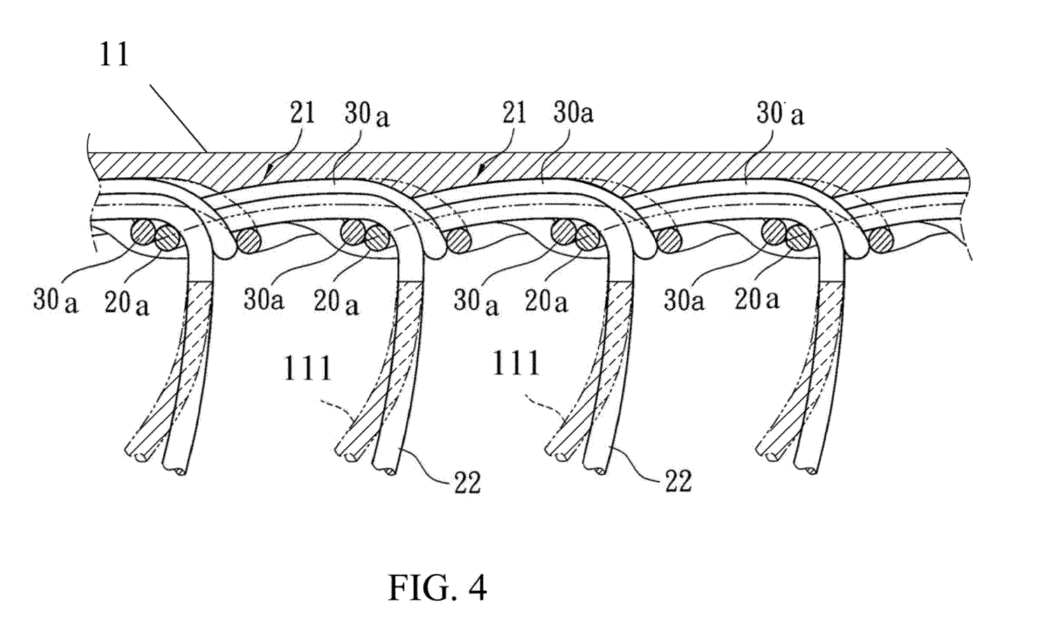

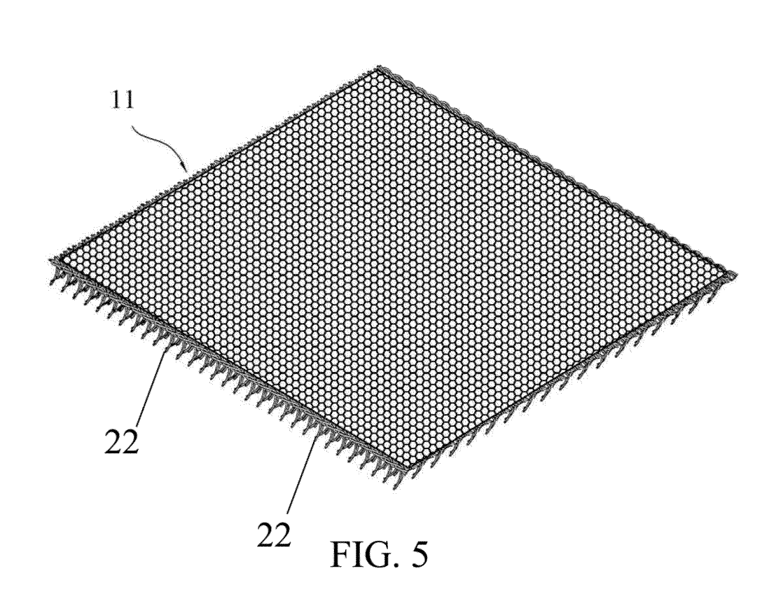

Refer to FIGS. 1-5 at the same time, the present invention provides a multi-layer pad structure through needle punching working procedure. The multi-layer pad structure comprises a material layer 10 and a base layer 11. The material layer 10 and the base layer 11 are combined tightly through a needle punching working procedure.

The material 10 is a wrap knitted fabric with at least one mesh 101, which is formed by a plurality of first fiber silks 20a and a plurality of second fiber silks 30a. The first fiber silks 20a are single-silk fibers and the second fiber silks 30a are synthetic fiber silks.

Each of the fiber silks 20a is bended as an U-shape ring with a ring part 21 and two tails 22 of single silk fiber for forming the mesh 101. Each ring part 21 is clasped with the ring part 21 of another first fiber silk 20a while the tails 22 go through the ring part 21 of another first fiber silk 20a. A single yarn 4 is formed by clasping several first fiber silks 20a in such way. One of the second fiber silks 30a is disposed beside each first fiber silk 20a of the single yarn 4 at one-first fiber silk interval. The one of the second fiber silks 30a is crosswise disposed beside the first fiber silks 20a of another single yarn 4, and crosswise disposed back beside the first fiber silks 20a of the single yarn 4. By such twisting way, the single yarn 4 is fixed with another single yarn 4, and then the material layer 10 is formed by twisting several single yarns 4.

In FIGS. 1 and 1A, “A” presents part of the material layer 10.

In the present invention, materials of the first fiber silks and the second fiber silks are selected from a group consisted of nylon, polyamide, polyester, polypropylene and polyethylene.

The base layer 11 is a non-woven fabric surface composed of a needle punching cotton silk fiber, and material of the needle punching cotton silk fiber is selected from a group consisted of acrylic, cotton and polyester staple fiber.

The material layer 10 is covered by the base layer 11. Meanwhile, through needle punching working procedure, a needle punching cotton silk fiber 111 of the base layer 11 is embedded into spaces between the first fiber silks 20a and the second fiber silks 30a and interknits therewithin so that the material layer 10 is combined with the base layer 11 tightly.

Further, through needle punching working procedure, the tails 22 of the material layer 10 are erected perpendicularly to the direction of the material layer 10. Therefore, the skew of the directionalities of the tails 22 can be decreased substantially and the skidproof effect of the material layer 10 against to any direction can be increased substantially at the same time.

Moreover, through needle punching working procedure, the material layer 10 and the base layer 11 could be stuck with other surface materials easily.

In the present invention, the material layer 10 and the base layer 11 are combined through needle punching working procedure. Therefore, not only the material layer 10 and the base layer 11 are combined tightly, but the defects of poor gluing level, high gluing cost, easy-deteriorated glue and non-environmentally protection existed in the previous multi-layer pad structure products can be improved.

The above disclosure is related to the particular of the implementable embodiment of the present invention. However, the embodiment is not intended to limit the claimed invention, and the modifications and replacements are not fully disclosed in the above descriptions, they have substantially been covered in the following claims as appended.

What is claimed is:

1. A multi-layer pad structure through needle punching working procedure, comprising:
a material layer which is a wrap knitted fabric with at least one mesh; and
a base layer, which is a non-woven fabric surface composed of a needle punching cotton silk fiber, being combined with the material layer tightly by embedding the needle punching cotton silk fiber into the material layer through needle punching working procedure.

2. The multi-layer pad structure as claimed in claim 1, wherein the material layer is composed of a plurality of first fiber silks and a plurality of second fiber silks, the first fiber silks are single silk fibers, the second fiber silks are synthetic fiber silks, and the needle punching cotton silk fiber of the base layer is embedded into spaces between the first fiber silks and the second fiber silks and interknits therewithin.

3. The multi-layer pad structure as claimed in claim 2, wherein each of the first fiber silks is bended as an U-shape ring with a ring part and two tails of single silk fiber for forming the mesh.

4. The multi-layer pad structure as claimed in claim 3, wherein the ring part is clasped with a ring part of another first fiber silk while the tails go through the ring part of another first fiber silk, and a single yarn is formed by clasping several first fiber silks.

5. The multi-layer pad structure as claimed in claim 4, wherein one of the second fiber silks is disposed beside each the first fiber silk of the single yarn at one-first fiber silk interval.

6. The multi-layer pad structure as claimed in claim 5, wherein the one of the second fiber silks is crosswise disposed beside the first fiber silks of another single yarn.

7. The multi-layer pad structure as claimed in claim 6, wherein the one of the second fiber silks is crosswise disposed back beside the first fiber silks of the single yarn.

8. The multi-layer pad structure as claimed in claim 7, wherein the single yarns forms a surface.

9. The multi-layer pad structure as claimed in claim 8, wherein materials of the first fiber silk and the second fiber silks are selected from a group consisted of nylon, polyamide, polyester, polypropylene and polyethylene.

10. The multi-layer pad structure as claimed in claim 9, wherein material of the needle punching cotton silk fiber is selected from a group consisted of acrylic, cotton and polyester staple fiber.
